(19) United States
(12) Patent Application Publication
(10) Pub. No.: US 2024/0162443 A1
(43) Pub. Date: May 16, 2024

(54) POSITIVE ELECTRODE FOR NONAQUEOUS ELECTROLYTE SECONDARY BATTERIES, METHOD FOR PRODUCING POSITIVE ELECTRODE FOR NONAQUEOUS ELECTROLYTE SECONDARY BATTERIES, AND NONAQUEOUS ELECTROLYTE SECONDARY BATTERY

(71) Applicant: Panasonic Energy Co., Ltd., Moriguchi-shi, Osaka (JP)

(72) Inventors: Yasuhiko Mukasa, Osaka (JP); Hideaki Fujiwake, Osaka (JP); Hiroyuki Fujimoto, Osaka (JP)

(73) Assignee: Panasonic Energy Co., Ltd., Moriguchi-shi, Osaka (JP)

(21) Appl. No.: 18/281,080

(22) PCT Filed: Mar. 10, 2022
(86) PCT No.: PCT/JP2022/010594

§ 371 Date: Sep. 8, 2023

(30) Foreign Application Priority Data
Mar. 26, 2021 (JP) 2021-052644

(51) Int. Cl. H01M 4/62; H01M 4/02; H01M 4/139

(52) U.S. Cl. CPC H01M 4/623; H01M 4/139; H01M 2004/021; H01M 2004/028

(57) ABSTRACT

The present invention provides a positive electrode for nonaqueous electrolyte secondary batteries, the positive electrode having improved adhesion, while suppressing variation in battery characteristics. A positive electrode for nonaqueous electrolyte secondary batteries according to one embodiment of the present disclosure comprises a positive electrode collector and a positive electrode mixture layer that is formed on the surface of the positive electrode collector; the positive electrode mixture layer contains a positive electrode active material, a conductive agent and a binder; the weight average molecular weight of the binder is 1,300,000 or more; and D10 and D90 in the particle size distribution of the binder satisfy (D90-D10)≥100 μm.

### TECHNICAL FIELD

The present disclosure relates to a positive electrode for non-aqueous electrolyte secondary battery, a method for producing a positive electrode for non-aqueous electrolyte secondary battery, and a non-aqueous electrolyte secondary battery.

### BACKGROUND

A certain amount of binder is contained in an electrode in order to ensure adhesion within an electrode material and between a mixture layer containing the electrode material and a current collector. In Patent Literature 1, there is disclosed a positive electrode containing, as a binder, a polyvinylidene fluoride (PVDF) having a weight average molecular weight of 500,000 to 1,000,000, and it is stated that a PVDF having a weight average molecular weight exceeding 1,000,000 is unfavorable because it causes deterioration of battery characteristics due to degradation in workability and reduction in uniformity.

### CITATION LIST

### Patent Literature

PATENT LITERATURE 1: Japanese Unexamined Patent Application Publication No. 2005-251684

### SUMMARY

### Technical Problem

In recent years, from the perspective of achieving a higher capacity, studies are being conducted for increasing the amount of active material and decreasing the amount of electrode materials other than the active material, such as a binder, in a mixture layer. As a result of intensive studies by the present inventors, it was found that when a binder having a large weight average molecular weight is used, although sufficient adhesion can be provided even with a relatively small amount, stability of the electrode mixture slurry becomes decreased, and variance in battery characteristics becomes increased. In the technique disclosed in Patent Literature 1, no consideration has been made regarding simultaneously achieving adhesion and stability of the electrode mixture slurry, and there is still room for improvement.

An object of the present disclosure is to provide a positive electrode for non-aqueous electrolyte secondary battery which has improved adhesion and which suppresses variance in battery characteristics.

### Solution to Problem

A positive electrode for non-aqueous electrolyte secondary battery according to one aspect of the present disclosure includes a positive electrode current collector and a positive electrode mixture layer formed on a surface of the positive electrode current collector. The positive electrode mixture layer contains a positive electrode active material, a conductive agent, and a binder. The weight average molecular weight of the binder is 1,300.000 or more. In the particle size distribution of the binder. D10 and D90 satisfy D90-D10≥100 μm.

A method for producing a positive electrode for non-aqueous electrolyte secondary battery according to one aspect of the present disclosure includes: a positive electrode mixture slurry preparation step of preparing a positive electrode mixture slurry by kneading a positive electrode active material, a conductive agent, and a binder; and a positive electrode mixture layer formation step of forming a positive electrode mixture layer by applying the positive electrode mixture slurry onto a surface of a positive electrode current collector and performing drying and rolling. The weight average molecular weight of the binder is 1,300.000 or more. In the particle size distribution of the binder, D10 and D90 satisfy D90-D10≥100 μm.

A non-aqueous electrolyte secondary battery according to one aspect of the present disclosure includes the above-described positive electrode for non-aqueous electrolyte secondary battery, a negative electrode, and a non-aqueous electrolyte.

### Advantageous Effects of Invention

According to a non-aqueous electrolyte secondary battery according to one aspect of the present disclosure, it is possible to simultaneously achieve improvement in electrode adhesion and suppression of variance in battery characteristics.

### BRIEF DESCRIPTION OF DRAWINGS

FIG. 1 is an axial cross-sectional view of a non-aqueous electrolyte secondary battery according to an example embodiment.

### DESCRIPTION OF EMBODIMENTS

An example embodiment of a non-aqueous electrolyte secondary battery according to the present disclosure will be described below in detail. Although a cylindrical battery in which a spiral-type electrode assembly is housed in a cylindrical outer casing is described below as an example, the electrode assembly is not limited to being of a spiral type, and may be of a laminated type formed by alternately laminating a plurality of positive electrodes and a plurality of negative electrodes one by one via separators. Further, the outer casing is not limited to being cylindrical, and may be, for example, rectangular, coin-shaped, or the like, or may be a pouch-shaped casing composed of a laminate sheet including a metal layer and a resin layer.

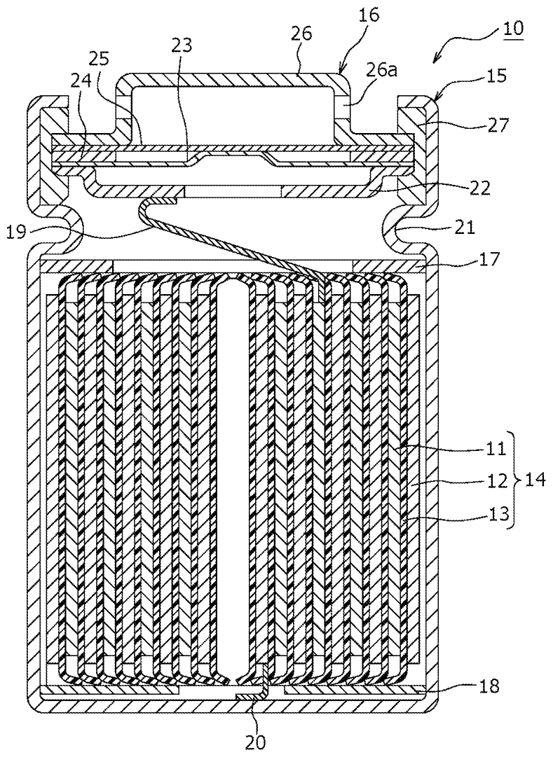

FIG. 1 is an axial cross-sectional view of a cylindrical secondary battery 10 according to an example embodiment. In the secondary battery 10 shown in FIG. 1, an electrode assembly 14 and a non-aqueous electrolyte (not shown in drawing) are housed in an outer casing 15. The electrode assembly 14 has a spiral structure formed by winding a positive electrode 11 and a negative electrode 12 with an interposed separator 13. In the following, for convenience of explanation, a side toward a sealing assembly 16 will be described as “upper”, and a side toward the bottom portion of the outer casing 15 will be described as “lower”.

By having an opening end portion of the outer casing 15 being closed with the sealing assembly 16, the interior of the secondary battery 10 is hermetically sealed. Insulation plates 17 and 18 are provided above and below the electrode assembly 14, respectively. A positive electrode lead 19 extends upward through a through hole in the insulation plate 17, and is welded to a lower surface of a filter 22, which is the bottom plate of the sealing assembly 16. In the secondary battery 10, a cap 26, which is the top plate of the sealing assembly 16 electrically connected to the filter 22, serves as the positive electrode terminal. Further, a negative electrode lead 20 passes through a through hole in the insulation plate 18, extends toward the bottom portion of the outer casing 15, and is welded to the inner surface of the bottom portion of the outer casing 15. In the secondary battery 10, the outer casing 15 serves as the negative electrode terminal. In cases where the negative electrode lead 20 is provided at an end edge portion, the negative electrode lead 20 passes through the through hole in the insulation plate 18, extends toward the bottom portion of the outer casing 15, and is welded to the inner surface of the bottom portion of the outer casing 15.

The outer casing 15 is, for example, a bottomed cylindrical metal outer can. A gasket 27 is provided between the outer casing 15 and the sealing assembly 16, and hermetic sealing of the interior of the secondary battery 10 is thereby ensured. The outer casing 15 has a grooved portion 21, which is formed, for example, by pressing a side surface portion from outside, and which supports the sealing assembly 16. The grooved portion 21 is preferably formed in an annular shape along the circumferential direction of the outer casing 15, and supports the sealing assembly 16 on its upper surface via the gasket 27.

The sealing assembly 16 comprises the filter 22, a lower valve member 23, an insulation member 24, an upper valve member 25, and the cap 26, which are stacked in this order from the electrode assembly 14 side. Each of the members constituting the sealing assembly 16 has, for example, a disk shape or a ring shape, and the respective members other than the insulation member 24 are electrically connected to each other. The lower valve member 23 and the upper valve member 25 are connected to each other at their central portions, and the insulation member 24 is interposed between peripheral edge portions of these valve members. When the internal pressure of the battery increases due to abnormal heat generation, for example, the lower valve member 23 ruptures, and the upper valve member 25 is thereby caused to swell toward the cap 26 side and separate from the lower valve member 23, so that electrical connection between the two valve members is cut off. When the internal pressure increases further, the upper valve member ruptures, and gas is discharged from an opening 26a in the cap 26.

A detailed description will be given below regarding the positive electrode 11, the negative electrode 12, and the separator 13, which constitute the electrode assembly 14, and the non-aqueous electrolyte, and in particular regarding the positive electrode 11.

[Positive Electrode]

The positive electrode 11 comprises a positive electrode current collector and a positive electrode mixture layer formed on a surface of the positive electrode current collector. The positive electrode mixture layer is preferably formed on both sides of the positive electrode current collector. As the positive electrode current collector, it is possible to use; a foil of a metal, such as aluminum or an aluminum alloy, that is stable in the potential range of the positive electrode; a film having such a metal disposed on its surface layer; and the like. The thickness of the positive electrode current collector is, for example, 10 μm to 30 μm.

The positive electrode mixture layer contains a positive electrode active material, a conductive agent, and a binder. The thickness of the positive electrode mixture layer on one side of the positive electrode current collector is, for example, 10 μm to 150 μm. A method for producing the positive electrode mixture layer includes a positive electrode mixture slurry preparation step of preparing a positive electrode mixture slurry by kneading the positive electrode active material, the conductive agent, and the binder, and a positive electrode mixture layer formation step of forming a positive electrode mixture layer by applying the positive electrode mixture slurry onto a surface of the positive electrode current collector and performing drying and rolling.

On the positive electrode 11, there may be provided a positive electrode exposed portion where a surface of the positive electrode current collector is exposed. To the positive electrode exposed portion, a positive electrode lead 19 is connected by ultrasonic welding or the like. The positive electrode exposed portion is preferably provided on both sides of the positive electrode 11 at positions overlapping each other in the thickness direction of the positive electrode 11. Although the positive electrode exposed portion may be provided at an inner winding end portion or an outer winding end portion of the positive electrode 11, in consideration of current collection property, the positive electrode exposed portion is preferably provided at a position substantially equidistant from the inner winding end portion and the outer winding end portion. By connecting the positive electrode lead 19 to the positive electrode exposed portion provided at such a position, when the electrode assembly 14 is wound, the positive electrode lead 19 is arranged substantially at a midpoint in the radial direction in a manner protruding upward from an end face, in the width direction, of the electrode assembly 14. The positive electrode exposed portion is formed, for example, by intermittent application of the positive electrode mixture slurry, according to which the slurry is not applied to apart of the positive electrode current collector.

Examples of the positive electrode active material contained in the positive electrode mixture layer include lithium transition metal oxides containing transition metal elements such as Co, Mn, and Ni. The lithium transition metal oxides are, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, Li₁₋ₓMn₂O₄, LiₓMn_{2-y}M_{y}O₄, LiMPO₄, and Li₂MPO₄F (where M is at least one of Na, Mg. Sc, Y. Mn, Fe. Co, Ni, Cu, Zn, Al, Cr, Pb, Sb, and B; 0<x≤1.2, 0<y≤0.9, and 2.0≤z≤2.3). A single type among these may be used alone, or a plurality of types may be mixed and used. In terms of enabling an increase in capacity of the non-aqueous electrolyte secondary battery, the positive electrode active material preferably contains a lithium nickel composite oxide such as LiₓNiO₂, LiₓCo_{y}Ni_{1-y}O₂, and LiₓNi_{1-y}M_{y}O_{z}, (where M is at least one of Na, Mg, Sc, Y, Mn, Fe, Co, Ni, Cu, Zn. Al, Cr, Pb, Sb, and B; 0<x≤1.2, 0<y≤0.9, and 2.0≤z≤2.3).

Examples of the conductive agent contained in the positive electrode mixture layer include carbon-based particles such as carbon black (CB), acetylene black (AB), Ketjen black, carbon nanotubes (CNTs), graphene, and graphite. These may be used alone or by combining two or more thereof.

The weight average molecular weight of the binder contained in the positive electrode mixture layer is 1,300,000 or more. With this feature, adhesion between the positive electrode current collector and the positive electrode mixture layer can be improved. The upper limit of the weight average molecular weight of the binder is, for example, 2,000.000. The weight average molecular weight is measured by gel permeationchromatography.

In the particle size distribution of the binder, D10 and D90 satisfy D90-D10≥100 μm. In the binder, by increasing the molecular weight to 1,300,000 or more and also increasing the difference D90-D10 to 100 μm or more, reaggregation of the binder in the slurry is suppressed, and stability of the slurry is improved. Further, in the particle size distribution of the binder, D50 is preferably 60 μm to 200 μm. D10, D50, and D90 mean particle sizes at which, in a volume-based particle size distribution, the cumulative frequency from the smallest particle size reaches 10%, 50%, and 90%, respectively. A particle size distribution of a carbon nanotube dispersion for electrode slurry can be measured using a laser diffraction particle size distribution measuring device (for example, Mastersizer 3000 manufactured by Malvern Panalytical Ltd.).

Examples of the binder include fluororesins such as polytetrafluoroethylene (PTFE) and polyvinylidene fluoride (PVdF), polyacrylonitrile (PAN), polyimide resins, acrylic resins, and polyolefinresins. A single type among these may be used alone, or two or more types may be used in combination.

The binder is preferably PVDF, a derivative of PVDF, or a copolymer containing vinylidene fluoride (VDF). A PVDF derivative is PVDF into which a functional group has been introduced. The PVDF derivative is, for example, PVDF into which a carbonyl group has been introduced. With this feature, adhesion is improved. The copolymer containing VDF is, for example, a copolymer of VDF and other monomers. Examples of the other monomers include tetrafluoroethylene, hexafluoropropylene, tetrafluoroethylene, and the like.

In the positive electrode mixture layer, the binder content relative to 100 parts by mass of the positive electrode active material is preferably less than 1 part by mass, more preferably 0.9 parts by mass or less, and particularly preferably 0.7 parts by mass or less. With this feature, the content of the positive electrode active material in the positive electrode mixture layer can be increased, so that the battery capacity can be increased. The lower limit of the binder content relative to 100 parts by mass of the positive electrode active material is, for example, 0.1 part by mass or less.

[Negative Electrode]

The negative electrode 12 comprises a negative electrode current collector and a negative electrode mixture layer formed on a surface of the negative electrode current collector. The negative electrode mixture layer is preferably formed on both sides of the negative electrode current collector. As the negative electrode current collector, it is possible to use: a foil of a metal, such as copper or a copper alloy, that is stable in the potential range of the negative electrode; a film having such a metal disposed on its surface layer; and the like. The thickness of the negative electrode current collector is, for example, 5 μm to 30 μm.

The negative electrode mixture layer contains a negative electrode active material and a binder. The thickness of the negative electrode mixture layer on one side of the current collector is, for example, 10 μm to 150 μm. The negative electrode can be produced, for example, by applying a negative electrode mixture slurry containing the negative electrode active material, the binder, and the like onto the negative electrode current collector, drying the applied coating, and then rolling the product to thereby form negative electrode mixture layers on both sides of the negative electrode current collector.

On the negative electrode 12, there may be provided a negative electrode exposed portion where a surface of the negative electrode current collector is exposed. To the negative electrode exposed portion, a negative electrode lead 20 is connected by ultrasonic welding or the like. The negative electrode exposed portion is preferably provided on both sides of the negative electrode 12 at positions overlapping each other in the thickness direction of the negative electrode 12. The negative electrode exposed portion is formed, for example, at an inner winding end portion of the negative electrode 12. By connecting the negative electrode lead 20 to the negative electrode exposed portion provided at the inner winding end portion of the negative electrode 12, when the electrode assembly 14 is wound, the negative electrode lead 20 is arranged near the winding axis in a manner protruding downward from an end face, in the width direction, of the electrode assembly 14. The position at which the negative electrode exposed portion is formed is not limited to the inner winding end portion of the negative electrode 12, and may for example be provided at an outer winding end portion or the like. The negative electrode exposed portion is formed, for example, by intermittent application of the negative electrode mixture shiny, according to which the slurry is not applied to a part of the negative electrode current collector.

The negative electrode active material is not particularly limited so long as it can reversibly occlude and release lithium ions, and a carbon material such as graphite is generally used therefor. The graphite may be either natural graphite such as flake graphite, massive graphite, and earthy graphite, or artificial graphite such as massive artificial graphite and graphitized mesophase carbon microbeads. Further, as the negative electrode active material, it is possible to use a metal that forms an alloy with Li such as Si or Sn, a metal compound containing Si, Sn, or the like, a lithium titanium composite oxide, and so on. For example, in combination with graphite, a Si-containing compound represented by SiOₓ (where 0.5≤x≤1.6), a Si-containing compound in which fine particles of Si are dispersed in a lithium silicate phase represented by Li_{2y}SiO_{(2+y)} (where 0<y<2), or the like may be used.

As the binder contained in the negative electrode mixture layer, while it is possible to use fluororesins such as PTFE and PVDF, PAN, polyimides, acrylic resins, polyolefins, and the like as in the case of the positive electrode, it is preferable to use styrene-butadiene rubber (SBR). The negative electrode mixture layer may additionally contain CMC or a salt thereof polyacrylic acid (PAA) or a salt thereof polyvinyl alcohol (PVA), or the like. For example, the negative electrode mixture layer contains SBR together with CMC or a salt thereof.

[Separator]

As the separator, a porous sheet having ion permeability and insulation property is used. Specific examples of the porous sheet include a microporous thin film, woven fabric, and non-woven fabric. As the material of the separator, polyolefins such as polyethylene and polypropylene, cellulose, and the like are suitable. The separator may have either a single-layer structure or a laminate structure. Further, on a surface of the separator, there may be provided a layer of highly heat-resistant resin such as aramid resin, or a filler layer containing an inorganic compound filler.

[Non-Aqueous Electrolyte]

The non-aqueous electrolyte contains a non-aqueous solvent and an electrolyte salt dissolved in the non-aqueous solvent. As the non-aqueous solvent, it is possible to use, for example, esters, ethers, nitriles such as acetonitrile, amides such as dimethylfonnanide, a mixed solvent containing two or more of the foregoing, and the like. The non-aqueous solvent may contain a halogen-substituted product obtained by substituting at least a part of hydrogens in the above solvents with halogen atoms such as fluorine. Examples of the halogen-substituted product include fluorinated cyclic carbonate esters such as fluoroethylene carbonate (FEC), fluorinated chain carbonate esters, fluorinated chain carboxylate esters such as fluorinated methyl propionate (FMP), and the like.

Examples of the above-noted esters include: cyclic carbonate esters such as ethylene carbonate (EC), propylene carbonate (PC), and butylene carbonate; chain carbonate esters such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylate esters such as γ-butyrolactone (GBL) and γ-valerolactone (GVL); and chain carboxylate esters such as methyl acetate, ethyl acetate, propyl acetate, methyl propionate (MP), and ethyl propionate.

Examples of the above-noted ethers include: cyclic ethers such as 1,3-dioxolane, 4-methyl-1,3-dioxolane, tetrahydrofuran, 2-methyltetrahydrofran, propylene oxide, 1,2-butylene oxide, 1,3-dioxane, 1,4-dioxane, 1,3,5-trioxane, furan, 2-methylfuran, 1,8-cineole, and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The electrolyte salt is preferably lithium salt. Examples of lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ(where 1<x<6, and n is 1 or 2), LiB₁₀Cl₁₀, LiCl, LiBr, LiI, chloroborane lithium, lower aliphatic lithium carboxylate, borates such as Li₂B₄O₇ and Li(B(C₂O₄)F₂), and imide salts such as LiN(SO₂CF₃)₂ and LiN(C₁F₂₁₊₁SO₂)(CₘF₂ₘ₊₁SO₂) (where each of 1 and m is an integer of 0 or greater). As the lithium salt, a single type among the above may be used alone, or a plurality of types may be mixed and used. Among the foregoing, it is preferable to use LiPF₆ in consideration of ion conductivity, electrochemical stability, and the like. The concentration of the lithium salt is preferably 0.8 to 1.8 mol per 1 liter of the non-aqueous solvent.

### EXAMPLES

While the present disclosure will be further described below using Examples, the present disclosure is not limited to these Examples.

### Example 1

[Production of Positive Electrode]

As the positive electrode active material, a lithium transition metal oxide represented by LiNi_{0.8}Co_{0.15}Al_{0.05}O₂ was used. As the binder, polyvinylidene fluoride (PVDF) having a weight average molecular weight of 1,390,000 and a D90-D10 value of 133 μm was used. The positive electrode active material, acetylene black (AB) serving as the conductive agent, and the PVDF were mixed at a mass ratio of 100:0.8:0.7 and kneaded while adding N-methyl-2-pynolidone (NMP), and a positive electrode mixture slurry having a solid content ratio of 78.5% was thereby prepared. Next, this positive electrode mixture slurry was applied to both sides of a positive electrode current collector made of aluminum foil excluding a portion to which a lead was to be connected, and the applied coating was dried. Then, after the applied coating was rolled using a roller, the product was cut into a predetermined electrode size, and a positive electrode having positive electrode mixture layers formed on both sides of the positive electrode current collector was thereby produced.

[Evaluation of Stability of Positive Electrode Mixture Slurry]

Regarding the positive electrode mixture slurry immediately after slurry preparation and that after an elapse of 7 days from preparation, viscosity at 25° C. was measured using a B-type viscometer (VISCOMETER with H rotor, manufactured by Toki Sangyo Co., Ltd.). The ratio of the viscosity after 7 days to the viscosity immediately after preparation (i.e., (viscosity after 7 days)/(viscosity immediately after preparation)) was defined as a ratio of viscosity change, and was used as an index of stability of the positive electrode mixture slurry.

[Evaluation of Adhesion]

By cutting the above positive electrode, a test piece having a width of 15 mm and a length of 80 mm was produced. A double-sided tape (manufactured by Nitto Denko Corporation) was attached to the positive electrode mixture layer on one side of the test piece, and the test piece was fixed to a stainless steel substrate with a flat and smooth surface. The stainless steel substrate having the test piece fixed thereon was placed horizontally. One end of the positive electrode current collector in the lengthwise direction of the test piece was fixed to a movable jig of a tensile tester (product name: TENSILON universal testing instrument RTC1210, manufactured by A&D Co., Ltd.), and an arrangement was set up for peeling the positive electrode current collector in a 90° direction relative to the substrate surface of the stainless steel substrate. Then, the movable jig was moved, and the positive electrode mixture layer and the positive electrode current collector of the test piece were thereby peeled off of each other at a speed of 20 mm/min. At that time, the tensile direction was always maintained at 90° relative to the substrate surface of the stainless steel substrate on which the test piece was fixed. The numerical value of a stable tensile strength applied when the test piece was peeled by 30 mm or more was read off and used as the peel strength (N/m) of the positive electrode mixture layer with respect to the positive electrode current collector.

### Example 2

A positive electrode was produced in the same manner as in Example 1 except that PVDF having a weight average molecular weight of 1,820,000 and a D90-D10 value of 204 μm was used, and evaluations were performed.

### Comparative Example 1

A positive electrode was produced in the same manner as in Example 1 except that PVDF having a weight average molecular weight of 1,180,000 and a D90-D10 value of 73 μm was used, and evaluations were performed.

### Comparative Example 2

A positive electrode was produced in the same manner as in Example 1 except that PVDF having a weight average molecular weight of 1,400,000 and a D90-D10 value of 70 μm was used, and evaluations were performed.

Table 1 shows the results of evaluation of the ratio of viscosity change and the peel strength for the Examples and Comparative Examples. In Table 1, the ratios of viscosity change of Example 2 and Comparative Examples 1 and 2 are indicated as values relative to the ratio of viscosity change of Example 1, which is assumed to be 100. Table 1 also shows the weight average molecular weight and the D90-D10 value of the PVDF used as the binder.

TABLE 1

| | | D90 − | Ratio of | Peel |
|---|---|---|---|---|
| | Weight Average | D10 | Viscosity | Strength |
| | Molecular Weight | [μm] | Change | [N/m] |
| Example 1 | 1,390,000 | 133 | 100 | 8.38 |
| Example 2 | 1,820,000 | 204 | 41.5 | 7.67 |
| Comparative | 1,180,000 | 73 | 90 | 5.77 |
| Example 1 | | | | |
| Comparative | 1,400,000 | 70 | 130 | 8.36 |
| Example 2 | | | | |

As can be seen from Table 1, in both of Examples 1 and 2, as compared to Comparative Examples 1 and 2, improvement in stability of the positive electrode mixture slurry and improvement in peel strength could be simultaneously achieved. Accordingly, it is possible to improve adhesion of the positive electrode and also suppress variance in battery characteristics.

### REFERENCE SIGNS LIST

10 secondary battery; 11 positive electrode; 12 negative electrode; 13 separator; 14 electrode assembly; 15 outer casing; 16 sealing assembly; 17, 18 insulation plate; 19 positive electrode lead; 20 negative electrode lead; 21 grooved portion; 22 filter; 23 lower valve member; 24 insulation member; 25 upper valve member; 26 cap; 26a opening; 27 gasket.

1. A positive electrode for non-aqueous electrolyte secondary battery, comprising a positive electrode current collector and a positive electrode mixture layer formed on a surface of the positive electrode current collector, wherein
the positive electrode mixture layer contains a positive electrode active material, a conductive agent, and a binder,
a weight average molecular weight of the binder is 1,300,000 or more, and
in a particle size distribution of the binder, D10 and D90 satisfy D90-D10≥100 sm.

2. The positive electrode for non-aqueous electrolyte secondary battery according to claim 1, wherein, in the positive electrode mixture layer, a content of the binder relative to 100 parts by mass of the positive electrode active material is less than 1 part by mass.

3. The positive electrode for non-aqueous electrolyte secondary battery according to claim 1, wherein the binder is at least one of polyvinylidene fluoride, a derivative of polyvinylidene fluoride, and a copolymer containing vinylidene fluoride.

4. A method for producing a positive electrode for non-aqueous electrolyte secondary battery, comprising:
a positive electrode mixture slurry preparation step of preparing a positive electrode mixture slurry by kneading a positive electrode active material, a conductive agent, and a binder; and
a positive electrode mixture layer formation step of forming a positive electrode mixture layer by applying the positive electrode mixture slurry onto a surface of a positive electrode current collector and performing drying and rolling, wherein
a weight average molecular weight of the binder is 1,300,000 or more, and
in a particle size distribution of the binder, D10 and D90 satisfy D90-D10≥100 sm.

5. A non-aqueous electrolyte secondary battery, comprising the positive electrode for non-aqueous electrolyte secondary battery according to claim 1, a negative electrode, and a non-aqueous electrolyte.
